(19) United States
(12) Patent Application Publication
(10) Pub. No.: US 2008/0263031 A1
(43) Pub. Date: Oct. 23, 2008

(54) METHOD AND APPARATUS FOR CREATING SEARCHES IN PEER-TO-PEER NETWORKS

(76) Inventors: David A. George, Somers, NY (US); Raymond B. Jennings, III, Ossining, NY (US); Jason D. La Voie, Mahopac, NY (US)

Correspondence Address: Moser, Patterson & Sheridan, LLP, Suite 100, 595 Shrewsbury Avenue, Shrewsbury, NJ, 07702, US

(21) Appl. No.: 12/163,469

(22) Filed: Jun. 27, 2008

Related U.S. Application Data
(63) Continuation of application No. 11/152,887, filed on Jun. 15, 2005.

(51) Int. Cl. G06F 7/06; G06F 15/16; G06F 17/30

(52) U.S. Cl. 707/5; 709/201; 709/203; 707/E17.008; 707/E17.017

(57) ABSTRACT

One embodiment of the present method and apparatus for creating searches in peer-to-peer networks includes forming clusters comprising data from a user's media library and formulating at least one search request message in accordance with the clusters. Formation of the clusters may be guided at least in part by data attributes that the user indicates are important. In this way, the user's media library may be “mined” for information that will aid in creating searches for data that the user may be interested in, but may not necessarily know how to search for or may not necessarily know exists.

### CROSS REFERENCE TO RELATED APPLICATIONS

This application is a continuation of co-pending U.S. patent application Ser. No. 11/152,887, filed Jun. 15, 2005, entitled “METHOD AND APPARATUS FOR CREATING SEARCHES IN PEER-TO-PEER NETWORKS”, which is herein incorporated by reference in its entirety.

### BACKGROUND

The present invention relates generally to computing networks and relates more particularly to searching peer-to-peer data transfer networks.

FIG. 1 is a schematic diagram of a network 100 of nodes (e.g., computing devices) interacting in a peer-to-peer (P2P) manner. Generally, a requesting node 101 sends a search request message 105 (e.g., containing keywords relating to data that the requesting node 101 wishes to locate) to at least one intermediate node 111 in communication with the requesting node 101 via a peer connection. The intermediate node 111 receives the search request message 105 and forwards the search request message 105 to at least one additional node 111. Eventually, the search request message 105 reaches at least one responding node 103 having the requested data (in some cases, the first intermediate node 111 to which the search request message 105 is forwarded will also be a responding node 103). At least one responding node 103 then sends a response message 107 back to the requesting node 101, e.g., via the intermediate nodes 111. The requesting node 101 then requests the relevant data from a responding node 103 by connecting directly to the responding node 103, e.g., via direct connection 109.

In conventional P2P systems, search request messages such as the search request message 105 are manually constructed by a user. Some P2P systems also save old search request messages previously constructed by the user, e.g., for the purposes of re-sending the old search messages at a later time to obtain new response messages. However, there is no way for a user to find data that he or she may be particularly interested in if he or she is not aware of the existence of the data (e.g., an obscure recording by a favorite musician). This is because typical P2P searches are limited to the keywords that are entered by the user in the search request message.

In addition, lack of knowledge about optimal times to send search request messages may hamper a user's ability to obtain the best results (e.g., response messages). If a user does not receive satisfactory results in response to an initial search request message, he or she may choose to periodically re-send the search request message until satisfactory results are obtained. However, because the user is typically unaware of the states of other users on the network (e.g., if other users are backlogged fulfilling data requests, or if other users are generating error messages), this approach is hit or miss and may not necessarily produce better results.

Thus, there is a need in the art for a method and apparatus for creating searches in P2P networks.

### SUMMARY OF THE INVENTION

One embodiment of the present method and apparatus for creating searches in peer-to-peer networks includes forming clusters comprising data from a user's media library and formulating at least one search request message in accordance with the clusters. Formation of the clusters may be guided at least in part by data attributes that the user indicates are important. In this way, the user's media library may be “mined” for information that will aid in creating searches for data that the user may be interested in, but may not necessarily know how to search for or may not necessarily know exists.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a network of nodes interacting in a peer-to-peer manner;

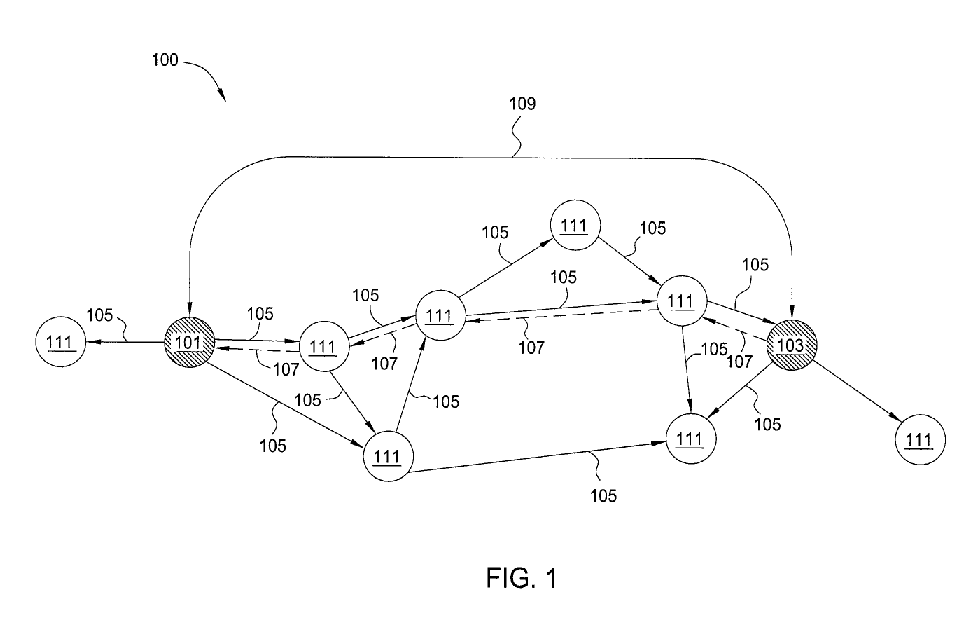

FIG. 2 is a flow diagram illustrating one embodiment of a method for creating searches in P2P networks, according to the present invention;

FIG. 3 is a flow diagram illustrating one embodiment of a method for automatically issuing search request messages, according to the present invention; and

FIG. 4 is a high level block diagram of the search creation method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for creating searches in P2P networks. Embodiments of the present invention make it possible for a user to search for data of which he or she might not have thought or of which he or she may not even be aware, based on data that the user has already obtained. In this manner, a user may effectively search for new data that may be of particular interest to him or her.

For the purposes of the present invention, the term “node” refers to a computing device such as a personal computing device (e.g., a desk top computer, a laptop computer, a cellular telephone, a personal digital assistant, etc.), a server, a router or the like that is connected to a P2P network.

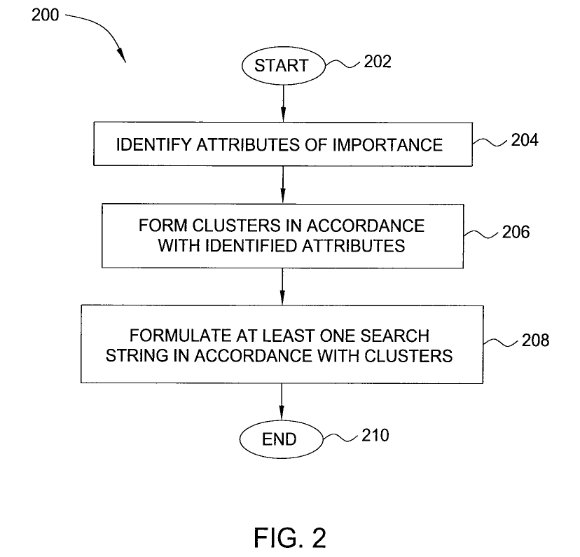

FIG. 2 is a flow diagram illustrating one embodiment of a method 200 for creating searches in P2P networks, according to the present invention. The method 200 may be implemented at, for example, a node in a P2P network.

The method 200 is initialized in step 202 and proceeds to step 204, where the method 200 identifies data attributes that are of importance to a user. These attributes describe data that the user may wish to search for (e.g., particular musicians, songwriters or producers that the user likes). In one embodiment, these attributes are provided by the user (e.g., via a feature vector that describes the attributes). In further embodiments, these attributes may be weighted such that each attribute is assigned a respective weight indicative of its importance to the user relative to other attributes.

Once the attributes of importance have been identified, the method 200 proceeds to step 206 and forms clusters out of data in a local media library comprising, for example, audio and video data (e.g., the user's media library), in accordance with the identified attributes. In one embodiment, each cluster formed by the method 200 is defined by one or more identified attributes that are common to the individual data that form the cluster. Thus, the identification of the attributes in step 204 may be thought as a way to fine-tune the more coarse-grained techniques applied in the clustering step 206.

In one embodiment, any known clustering technique may be implemented in step 206 to form the clusters of data, including micro-clustering techniques. As different clustering algorithms tend to have different time and space complexities, the selection of a specific clustering technique may be guided by the desired results. For example, different clustering algorithms will produce different results in terms of both the size and the content of the clusters produced. Certain clustering algorithms will create a fixed number, or a maximum number, of clusters. Still other clustering algorithms may be better suited for broad clustering or deep clustering, and some clustering algorithms are capable of running in non-linear time and may have to be limited in terms of how long they are allowed to run (e.g., typically the longer an algorithm is allowed to run, the better the potential search criteria that is ultimately generated).

In step 208, the method 200 formulates at least one search string in accordance with the clusters formed in step 206. For example, the method 200 may recognize, after clustering the data in the media library, that the media library contains a large number of music files produced by the same producer, or featuring the same background singer. In such a case, the method 200 might formulate a new search string to search for other music files produced by that same producer, or featuring that same background singer. In further embodiments, the method 200 might combine information from two or more individual clusters to produce a single search string.

In one embodiment, formulation of a search string in accordance with step 208 includes receiving supplemental information from external (e.g., external to the P2P network) sources, such as an external database (e.g., Gracenote's CD Data Base, or other music or data recognition services). This supplemental information relates to the content of the media library. For example, an external source may take a hash of a music file in the media library and determine what the associated song title or album is.

In step 210, the method 200 terminates. Search strings generated by the method 200 may then be propagated through the network as search request messages in accordance with any method for propagating searches through a computing network.

The method 200 thereby enables a user of a dynamic data transfer network, such as a P2P network, to search for data of which the user may not have thought, or to formulate a search message in a manner that the user may not have tried or to search for data that the user may not even be aware exists. By examining the user's media library for commonalties among the data contained therein (e.g., as indicated by the clusters and identified attributes of importance), the method 200 can also ensure that the generated search request messages target data that may be of particular interest to the user.

Those skilled in the art will appreciate that in some embodiments, multiple clustering algorithms and/or multiple combinations of attributes of importance may be applied in steps 204 and 206 in order to determine which clustering algorithm and/or set of attributes produces the most desirable results.

Moreover, the particular clustering algorithm or algorithms that are applied in step 206 may be shared as a file on the network by the user, e.g., in order to aid other users with their searches. For example, if a first user downloads data of a particular genre from a second user (e.g., heavy metal music files), the first user may also find it helpful to download a clustering algorithm used by the second user for searching for other heavy metal music files.

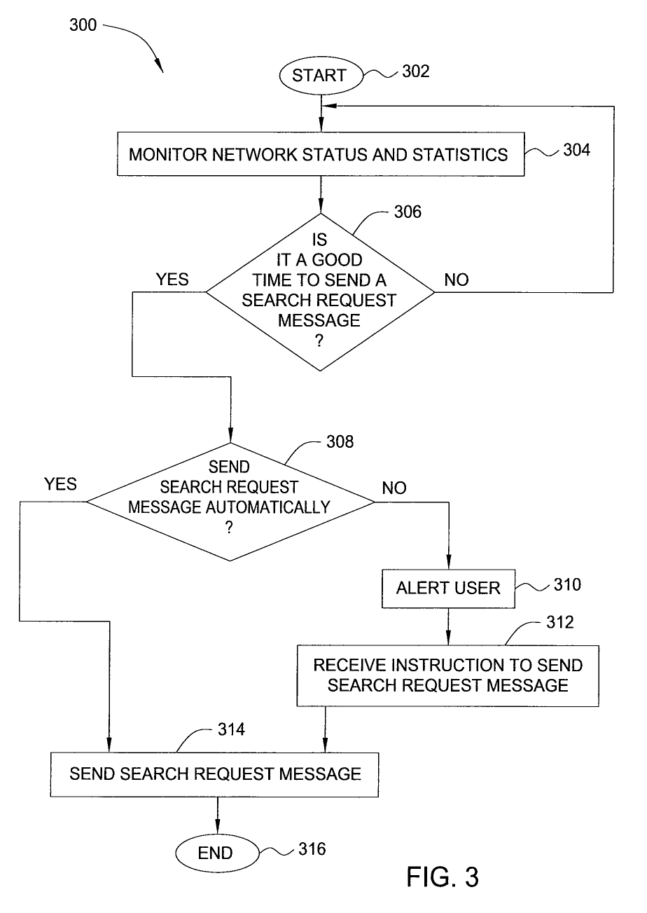

FIG. 3 is a flow diagram illustrating one embodiment of a method 300 for automatically issuing search request messages, according to the present invention. For example, the method 300 may be implemented to issue an automatically generated search message, such as a search message created in accordance with the method 200 described above. The method 300 may be executed at, for example, a node connected to a dynamically changing network.

The method 300 is initialized at step 302 and proceeds to step 304, where the method 300 monitors the network status and statistics. In one embodiment, these statistics are gathered from messages received by neighbor nodes directly or indirectly connected to a requesting node (e.g., a node at which the method 300 executes). In one embodiment, relevant statistics to monitor in accordance with step 304 include at least one of: the rate of turnover or change among the neighbor nodes (e.g., whether the network has reached a “steady state”), a ratio of input (e.g., received) messages to output (e.g., sent) messages at the neighbor nodes, the number of error messages or rejections received over a finite period of time for the neighbor nodes, the ratio of super nodes to non-super nodes that are connected to the node at which the method 300 executes, the ratio of bytes received by the requesting node to the number of neighbor nodes connected to the requesting node, the number of bytes received by the expiration of a search request message's hop count or time to live, the number of bytes received per P2P protocol version and the average amount of data being shared, per node.

In step 306, the method 300 determines, based on the monitored network status and statistics, whether it may be a “good” (e.g., optimal, in terms of receiving the desired results) time to send a new search request message through the network. For example, in one embodiment, a determination as to whether it may be a good time to send a search request message is based on the network's stability, or the rate of turnover or change among the neighbor nodes to the requesting node. If the network has reached a steady state (e.g., few new nodes are joining the network and few existing nodes are leaving the network), this state may imply that the existing nodes have been present in the network for a long time and will likely be able to respond to a new search request message without going offline (e.g., leaving the network) in the near future. Or, alternatively, the steady network state may imply that the nodes that have been present in the network for a long time are busy fulfilling previous requests for data (and may have a backlog), in which case it may not be an optimal time to send a new search request message.

In terms of re-sending old search request messages, if the network has reached a steady state, this state may imply that it is not a good time to re-send a search request, because it is likely that substantially the same search results will be received (since the network topology has not changed significantly). However, a non-steady network state may imply that it is a good time to re-send a search request message since there is likely a large number of new nodes within the horizon. In general, a steady state indicates the existence of less control traffic, but possibly more data traffic.

In another embodiment, a determination as to whether it may be a good time to send a search request message is based on the ratio of input (e.g., received) messages to output (e.g., sent) messages at the neighbor nodes. A higher number of input messages may indicate that more nodes in the P2P network are performing searches at a given time, whereas a higher number of output messages may indicate that more nodes are downloading data from other nodes in the P2P network at the given time.

In another embodiment, a determination as to whether it may be a good time to send a search request message is based on a number of error messages or rejections received over a finite period of time for the neighbor nodes. The higher the number of error messages, the more likely it is that one or more nodes in the P2P network are not operating properly (and therefore, the less likely it is that it is a good time to issue a new search request). The higher the number of rejections, the more likely it is that local horizon is running close to its maximum number of nodes (e.g., each node in the P2P network has the maximum number of connections that it can handle).

In another embodiment, a determination as to whether it may be a good time to send a search request message is based on the ratio of super nodes to non-super nodes that are connected to the requesting node. That is, if the requesting node is connected to more super nodes than non-super nodes, new search requests issued by the method 200 may have a better chance of receiving a better quality response or of receiving more responses. For the purposes of the present invention, a super node is a node that shields other non-super nodes (or leaf nodes) in order to reduce network traffic. Thus, where a non-super node might typically have approximately three open connections to other nodes, a super node might have on the order of approximately forty or more open connections to non-super nodes, as well as a handful of open connections to other super nodes.

In another embodiment, a determination as to whether it may be a good time to send a search request message is based on the ratio of bytes received by requesting node to the number of neighbor nodes connected to the requesting node. This ratio may indicate how busy the neighbor nodes and/or the P2P network in general is.

In another embodiment, a determination as to whether it may be a good time to send a search request message is based on the number of bytes received by the requesting node by the expiration of a search request message issued from that node's hop count or time to live. In one embodiment, an indication of how balanced a node's view of the network is can be derived from a histogram of the number of bytes received by the node by the expiration of a search request message issued from that node's hop count or time to live. For example, a histogram showing a high byte count with high time to live values may indicate that there is more activity close to the associated node or little activity outside of the associated node's neighbor nodes (e.g., as if the neighbor nodes were on a fringe of the network or within a pocket in the network). Similarly, a histogram showing a high byte count with low time to live values may indicate that the majority of the network traffic is being propagated among a small set of far-away nodes, and search request messages may not travel far enough into the network to produce the desired results.

In another embodiment, a determination as to whether it may be a good time to send a search request message is based on the number of bytes received by the requesting node per P2P protocol version present in the network. This information may indicate how many nodes using an older protocol are within the view of the requesting node. If, for example, there is a high byte count corresponding to older protocol versions, then the nodes running the old protocol version may not have all of the functionality desired by the requesting node. Thus, a high byte count corresponding to newer protocol versions may be desirable.

In another embodiment, a determination as to whether it may be a good time to send a search request message is based on the average number of files being shared per node in the network. In one embodiment, the standard deviation of this average number may indicate how busy the nodes in the network are. For example, a flat distribution of files being shared by each node may indicate that each node is equally busy, or equally likely to supply the requested data to the requesting node (e.g., because there is no single node or set of nodes that is performing most of the file transfers).

If the method 300 determines in step 306 that it is not a good time to send a search request message, the method 300 returns to step 304 and continues to monitor the network status and statistics (e.g., for the next optimal sending time).

Alternatively, if the method 300 determines in step 306 that it is a good time to send a search request message, the method 300 proceeds to step 308 and determines whether the search request message should be sent automatically (e.g., by the method 300, without user input). If the method 300 determines that the search request message should be sent automatically, the method 300 proceeds to step 314 and sends the search request message. In one embodiment, the search request message is optionally formulated in accordance with the method 200, although in other embodiments the search request message may be formulated in accordance with any method for formulating searches.

If, however, the method 300 determines in step 308 that the search request message should not be sent automatically (e.g., user input is required), the method 300 proceeds to step 310 and alerts the user to the fact that it is a good time to send the search request message. In one embodiment, the method 300 alerts the user by providing a constant visual display (e.g., a sliding bar) that indicates, at any given time, how good a time it is to send a search request message.

In step 312, the method 300 receives an instruction (e.g., from the user) to send the search request message. For example, the user may, based on the alert provided in step 310, provide some sort of feedback indicating the he or she would like to send a search request message now. The method 300 then sends the search request message in step 314, as discussed above. The method 300 terminates in step 316.

The method 300 thereby enables a user to determine an optimal time for sending a search request message, in order to maximize the number and quality of search results that are produced. By monitoring the network and examining statistics regarding network and node activity, the method 300 can infer the abilities of nodes in the network to respond to the search request message in a timely manner and with the desired data. Although the method 300 has been described as being implemented in conjunction with the method 200, those skilled in the art will appreciate that the method 200 and the method 300 may also be implemented to advantage independent of each other.

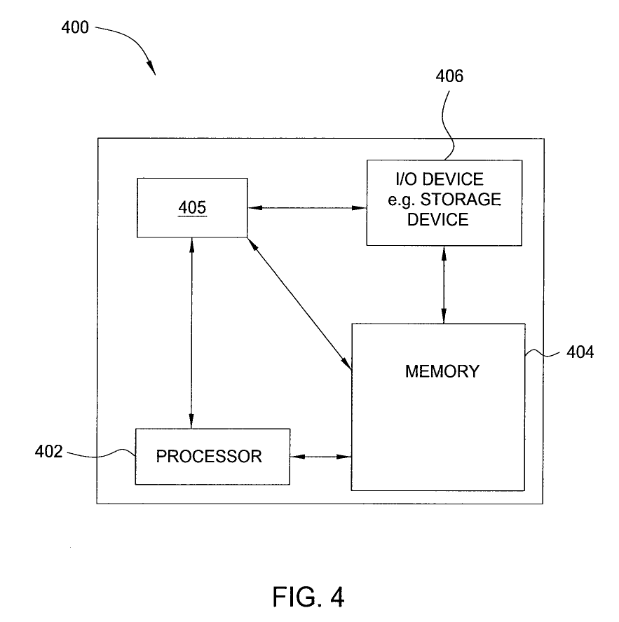

FIG. 4 is a high level block diagram of the search creation method that is implemented using a general purpose computing device 400. In one embodiment, a general purpose computing device 400 comprises a processor 402, a memory 404, a search creation module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the search creation module 405 can be implemented as a physical device or subsystem that is coupled to a processor through a communication channel.

Alternatively, the search creation module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the search creation module 405 for creating search request messages in a P2P network described herein with reference to the preceding Figures can be stored on a computer readable medium or carrier (e.g., RAM, magnetic or optical drive or diskette, and the like).

Thus, the present invention represents a significant advancement in the field of data transfer networks. A method and apparatus are provided that make it possible for a user to search for data of which he or she might not have thought or of which he or she may not even be aware, based on data that the user has already obtained. In this manner, a user may effectively search for new data that may be of particular interest to him or her.

While foregoing is directed to the preferred embodiment of the present invention, other and further embodiments of the invention may be devised without departing from the basic scope thereof, and the scope thereof is determined by the claims that follow.

1. A method for searching for data in a network, said method comprising:
forming one or more clusters comprising data from a media library; and
formulating at least one search request message in accordance with said one or more clusters.

2. The method of claim 1, wherein said one or more clusters are formed in accordance with one or more data attributes.

3. The method of claim 2, wherein said one or more data attributes are supplied by said user.

4. The method of claim 2, wherein said one or more data attributes are weighted based on relative importance.

5. The method of claim 2, wherein each of said one or more clusters is defined by at least one of said one or more data attributes, said at least one defining attribute being common to data contained within an associated cluster.

6. The method of claim 1, wherein said forming comprises:
applying a clustering algorithm to said data.

7. The method of claim 6, wherein a selection of said clustering algorithm is guided at least in part by desired search results.

8. The method of claim 1, wherein said formulating is further performed in accordance with supplemental information received from an external source.

9. The method of claim 8, wherein said supplemental information relates to said data in said media library.

10. The method of claim 1, further comprising:
propagating said search request message through said network.

11. A computer readable medium containing an executable program for searching for data in a network, where the program performs the steps of:
forming one or more clusters comprising data from a media library; and
formulating at least one search request message in accordance with said one or more clusters.

12. The computer readable medium of claim 11, wherein said one or more clusters are formed in accordance with one or more data attributes.

13. The computer readable medium of claim 12, wherein said one or more data attributes are supplied by said user.

14. The computer readable medium of claim 12, wherein said one or more data attributes are weighted based on relative importance.

15. The computer readable medium of claim 12, wherein each of said one or more clusters is defined by at least one of said one or more data attributes, said at least one defining attribute being common to data contained within an associated cluster.

16. The computer readable medium of claim 11, wherein said forming comprises:
applying a clustering algorithm to said data.

17. Apparatus comprising:
means for forming one or more clusters comprising data from a media library; and
means for formulating at least one search request message in accordance with said one or more clusters.

18. A method for propagating a search request message in a network, the method comprising:
monitoring a status of said network; and
determining an optimal time to send said search request message in accordance with said network status.

19. The method of claim 18, wherein said monitoring comprises:
determining if said network has reached a substantially steady state.

20. The method of claim 18, wherein said monitoring comprises:
determining a ratio of input messages to output messages at least one neighbor node.

21. The method of claim 18, wherein said monitoring comprises:
determining a number of error messages received at least one neighbor node over a finite period of time.

22. The method of claim 18, wherein said monitoring comprises:
determining a number of rejections received at least one neighbor node over a finite period of time.

23. The method of claim 18, wherein said monitoring comprises:
determining a ratio of super neighbor nodes to non-super neighbor nodes.

24. The method of claim 18, wherein said monitoring comprises:
determining a ratio of bytes received to a number of neighbor nodes.

25. The method of claim 18, wherein said monitoring comprises:
determining a number of bytes received by an expiration of a search request message's hop count or time to live.

26. The method of claim 18, wherein said monitoring comprises:
determining a number of bytes received per data transfer protocol present in said network.

27. The method of claim 18, wherein said monitoring comprises:
determining an average number of files being shared per node in said network.

28. The method of claim 18, further comprising:
propagating said search request message if it is determined to be an optimal time to send said search request message.

29. The method of claim 18, further comprising:
alerting a user to an optimal time to send said search request message; and
sending said search request message, if said user instructs that said search request message should be sent.

30. A computer readable medium containing an executable program for propagating a search request message in a network, where the program performs the steps of:
monitoring a status of said network; and
determining an optimal time to send said search request message in accordance with said network status.
